(19) United States
(12) Patent Application Publication
(10) Pub. No.: US 2022/0385825 A1
(43) Pub. Date: Dec. 1, 2022

(54) IMAGE CAPTURING APPARATUS AND CONTROL METHOD OF THE SAME TO PERFORM FOCUS CONTROL USING EXPOSURE CONDITIONS

(71) Applicant: CANON KABUSHIKI KAISHA, Tokyo (JP)

(72) Inventor: Mitsuru Saotome, Kanagawa (JP)

(21) Appl. No.: 17/826,836

(22) Filed: May 27, 2022

(30) Foreign Application Priority Data
May 31, 2021 (JP) 2021-091805

(51) Int. Cl. H04N 5/232

(52) U.S. Cl. CPC H04N 5/232123; H04N 5/23229

(57) ABSTRACT

An image capturing apparatus includes an image capturing circuit configured to generate an image signal, a processor, and a memory storing instructions executed by the processor to perform operations including generating image data based on the image signal, determining, acquiring, calculating, and controlling. The determining determines a first exposure condition to be applied to a first region and a second exposure condition to be applied to a second region of the image capturing circuit. The acquiring acquires, based on the image data, a first evaluation value for the first region and a second evaluation value for the second region. The calculating calculates a third evaluation value for the image data based on the first and second evaluation value weighted based on the first and second exposure condition. The control performs focus control of an optical system based on the third evaluation value.

### BACKGROUND

### Technical Field

One disclosed aspect of the embodiments relates to auto focus control.

### Description of the Related Art

As an auto focus (AF) method of a digital camera, contrast AF is widely employed. In the contrast AF, first, image capturing is performed while moving, over a focus adjustment range, a focus lens of a shooting optical system that affects focus adjustment. Then, a high-frequency component is extracted from an output image signal within a given AF region to sequentially calculate the contrast evaluation values for focusing. A sum of the high-frequency components is used as the contrast evaluation value, and the larger value indicates that the lens is more in focus. Therefore, the focus lens is focused by moving it to the position at which the contrast evaluation value is maximum.

In general, in an image capturing apparatus such as a digital camera, the exposure condition is uniformly applied to the entire region of the image sensor (image capturing element or circuit). On the other hand, there has also been proposed an image sensor in which the region thereof can be divided into a plurality of regions and the exposure condition can be changed for each region. For example, Japanese Patent Laid-Open No. 2010-136205 discloses that an exposure time is set for each region so that a gain can be changed for each region. Further, Japanese Patent Laid-Open No. 2011-257758 discloses a method of shooting the entire image brightly and adjusting the AF so that the focus can be adjusted appropriately even in a dark scene.

However, in the image sensor in which the exposure condition is changed for each region, for example, in order to improve the visibility of the entire image, a high gain may be set in the region where an object is captured to be dark and a low gain may be set in the region where the object is captured to be bright. Accordingly, a case occurs in which, within one captured image, the region where the high gain is set (high-gain region) and the region where the low gain is set (low-gain region) are mixed. In the low-gain region, an accurate contrast evaluation value can be acquired since noise is low. On the other hand, the high-gain region is easily affected by noise and it becomes difficult to acquire an accurate contrast evaluation value. Therefore, when the high-gain region and the low-gain region are mixed, the accuracy of deriving the lens position at which the contrast evaluation value is maximum may deteriorate, and appropriate focusing may be difficult.

### SUMMARY

According to one aspect of the embodiments, an image capturing apparatus includes an image capturing circuit, a processor, and a memory. The image capturing circuit is configured to generate an image signal from an image of an object formed by an optical system. The memory storing instructions that, when executed by the processor, cause the processor to perform operations including an image processing unit, a determination unit, an acquisition unit, a calculation unit, and a control unit. The image processing unit is configured to generate image data based on the image signal. The determination unit is configured to determine a first exposure condition to be applied to a first region and a second exposure condition to be applied to a second region different from the first region in an image capturing surface of the image capturing circuit. The acquisition unit is configured to acquire, based on the image data, a first evaluation value indicating a degree of contrast in the first region and a second evaluation value indicating a degree of contrast in the second region. The calculation unit is configured to calculate a third evaluation value indicating a degree of contrast in the image data based on the first evaluation value and the second evaluation value weighted based on the first exposure condition and the second exposure condition. The control unit is configured to perform focus control of the optical system based on the third evaluation value.

The disclosure enables more suitable contrast AF.

Further features of the disclosure will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a view showing a captured image in which different gain settings are mixed (a first embodiment);

FIG. 2 is a block diagram showing the functional arrangement of an image capturing apparatus;

FIG. 3 is a flowchart illustrating an evaluation value deriving operation in the first embodiment;

FIG. 4 is a view showing a captured image in which different gain settings are mixed (a second embodiment);

FIG. 5 is a flowchart illustrating an evaluation value deriving operation in the second embodiment;

FIG. 6 is a view showing a captured image in which different gain settings are mixed (a third embodiment);

FIG. 7 is a flowchart illustrating an evaluation value deriving operation in the third embodiment; and

FIG. 8 is a block diagram showing the hardware arrangement of the image capturing apparatus.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted. In the following, the term “unit” may refer to a software context, a hardware context, or a combination of software and hardware contexts. In the software context, the term “unit” refers to an operation, a functionality, an application, a software module, a function, a routine, a set of instructions, or a program that can be executed by a programmable processor such as a microprocessor, a central processing unit (CPU), or a specially designed programmable device or controller. In the hardware context, the term “unit” refers to a hardware element, a circuit, an assembly, a physical structure, a system, a module, or a subsystem. It may include mechanical, optical, or electrical components, or any combination of them. It may include active (e.g., transistors) or passive (e.g., capacitor) components. It may include semiconductor devices having a substrate and other layers of materials having various concentrations of conductivity. It may include a CPU or a programmable processor that can execute a program stored in a memory to perform specified functions. It may include logic elements (e.g., AND, OR) implemented by transistor circuits or any other switching circuits. In the combination of software and hardware contexts, the term “unit” refers to any combination of the software and hardware contexts as described above.

### First Embodiment

As the first embodiment of an image capturing apparatus according to the disclosure, an image capturing apparatus that performs contrast AF (Auto Focus) will be taken as an example and described below.

<Apparatus Arrangement>

FIG. 2 is a block diagram showing the functional arrangement of the image capturing apparatus according to the first embodiment.

An image capturing unit or circuit 201 as an image sensor generates pixel data based on an object image formed on the light receiving surface via a lens 202 as an optical system. The optical system is configured to be capable of focus control. Further, here, the image capturing unit 201 as the image sensor is configured to include a plurality of unit regions for which exposure conditions can be set independently. A video processing unit or circuit 203 may include an image processing circuit or unit to perform image processing to convert the pixel data, which is an image signal obtained from the image capturing unit 201, into image data in a format readable by an external apparatus such as a PC. An output unit or circuit 204 transmits the image data obtained from the video processing unit 203 to the external apparatus.

An arithmetic unit or circuit 207 controls respective units of the image capturing apparatus. For example, the arithmetic unit 207 performs focus control or the like by controlling/driving the lens 202 via a lens control unit 205. Further, the arithmetic unit 207 obtains the pixel data from the video processing unit 203 and sequentially calculates the contrast evaluation values indicating the degrees of contrast of the image. Furthermore, the arithmetic unit 207 controls the exposure condition of the image capturing unit 201 via an exposure region control unit 206.

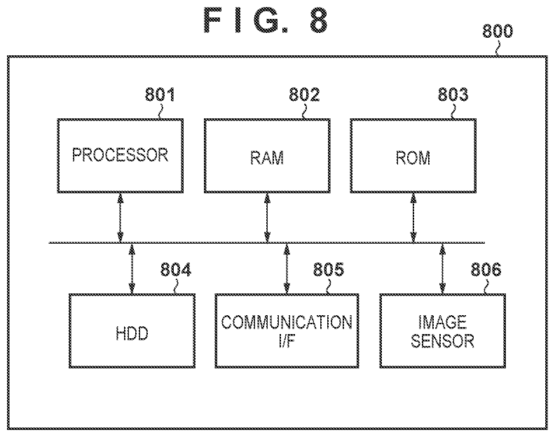

FIG. 8 is a block diagram showing the hardware arrangement of the image capturing apparatus. The image capturing apparatus includes, for example, a processor 801 such as a central processing unit (CPU), memories such as a random access memory (RAM) 802 and a read only memory (ROM) 803, and a storage apparatus such as a hard disk drive (HDD) 804. The image capturing apparatus also includes a communication interface (I/F) 805 for communication with an external apparatus, and an image sensor 806 for image capturing. The image capturing apparatus can execute various kinds of functions by the processor 801 executing programs stored in the memories and the storage apparatus. The CPU may execute instructions stored in the RAM 802 or ROM 803. The executed instructions may cause the CPU to perform operations described in the following. The operations may include operations performed by the video processing unit or circuit 203 or the arithmetic unit or circuit 207 or other units. Alternatively, the video processing unit 203 or the arithmetic unit 207 may include a programmable processor or circuit to execute instructions stored in a memory to perform operations as described in the following. These operations may include an image processing unit, a determination unit, an acquisition unit, a calculation unit, and a control unit.

### <Operation of Contrast AF>

An operation of focusing by contrast AF will be described. First, the arithmetic unit 207 drives the lens 202 over the focus adjustment range via the lens control unit 205. During the driving of the lens 202, the video processing unit 203 obtains pixel data output from the image capturing unit 201. The video processing unit 203 transmits, among the obtained pixel data, the pixel data within the AF region as the range for acquiring the contrast evaluation value to the arithmetic unit 207.

The arithmetic unit or circuit 207 extracts high-frequency components from the obtained pixel data within the AF region, and sequentially calculates the contrast evaluation values for focusing. Then, the arithmetic unit 207 determines the maximum value (at which the contrast is maximum) of the sequentially-calculated contrast evaluation values, and moves the lens 202 (focus lens here) to the position corresponding to the maximum value of the contrast evaluation values via the lens control unit 205.

As has been described above, in the first embodiment, the image capturing unit or circuit 201 as the image sensor is configured to include a plurality of unit regions for which exposure conditions (for example, gains) can be set independently. In this case, as will be described below, different from a case in which the exposure condition is uniformly set to the entire region of the image sensor, the contrast evaluation value of the entire region of the image cannot be derived simply. Note that in the following description, the gain is taken as an example and described as the exposure condition, but this embodiment is also applicable to another exposure condition concerning the noise amount (for example, the exposure time).

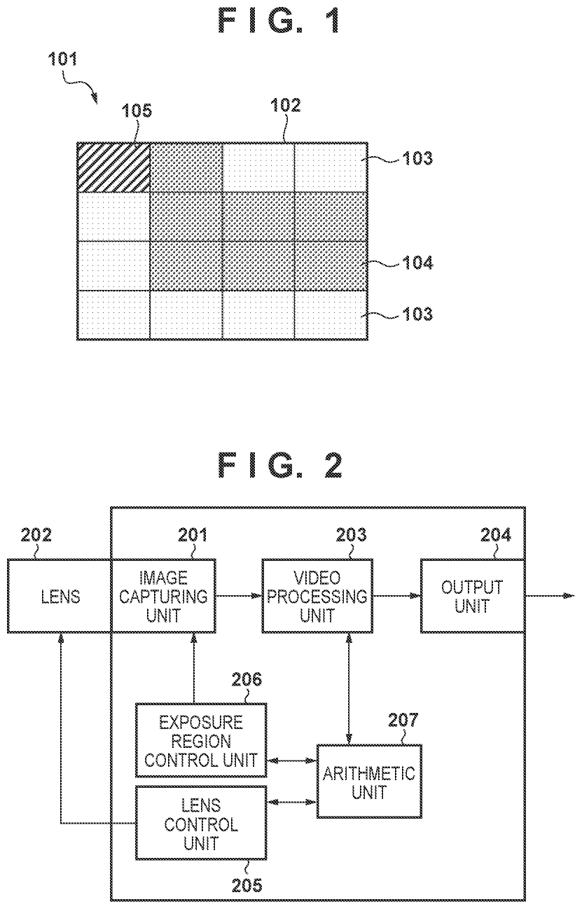

FIG. 1 is a view showing a captured image assumed in the first embodiment, in which different gain settings are mixed. More specifically, this is an example of a video in which, in a video 101 obtained by the entire region of the image sensor, an AF region 102 as the range for acquiring the contrast evaluation value covers the entire video (that is, matches the video 101). The entire region of the video 101 is formed by a plurality of unit regions 105 (a total of 16 unit regions of 4×4 in FIG. 1). Note that the unit region 105 means a region of the minimum unit for which an exposure condition (for example, a gain) can be set independently. In the video 101, nine low-gain regions 103 and seven high-gain regions 104 are set in the 16 unit regions 105.

Since images themselves are generally different among different unit regions, the contrast evaluation values derived in the respective unit regions are different from each other. Further, in the calculation of the contrast evaluation value, an image with a high gain is affected by noise more easily. Therefore, it is difficult to distinguish between the contrast evaluation value in a flat image region affected by noise and the contrast evaluation value in an edge region affected by noise. If the contrast evaluation values are not distinguished appropriately, an appropriate AF operation cannot be performed.

### <Operation of Apparatus>

To prevent this, in the first embodiment, the contrast evaluation value is acquired for each of the same exposure conditions, and weighting of the contrast evaluation value is calculated for each exposure condition. Thereafter, the contrast evaluation value of the entire video is determined.

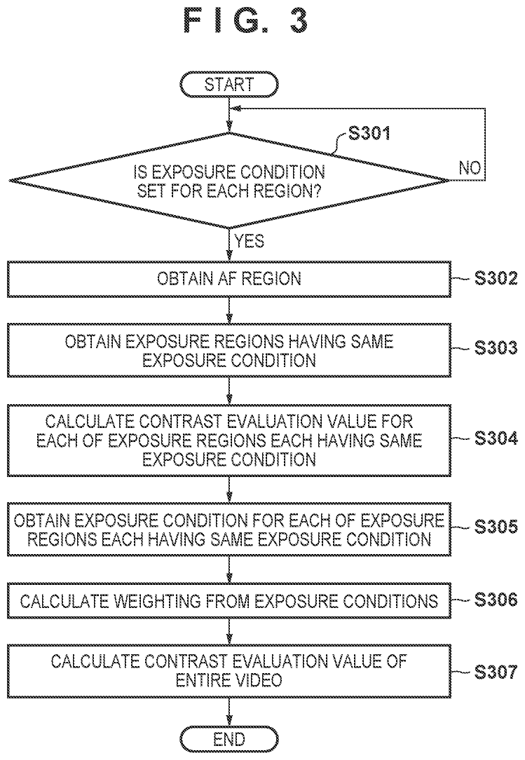

FIG. 3 is a flowchart illustrating an evaluation value deriving operation in the first embodiment. The following operation is started when an image capturing operation is started by a user pressing a button or the like.

In step S301, the arithmetic unit 207 determines whether the exposure condition is set for each region in the image sensor. For example, this determination is made by obtaining setting of the exposure condition from the exposure region control unit 206. If it is determined that the exposure condition is set for each region, the process advances to step S302. Note that if the exposure condition is not set for each region (that is, the exposure condition is the same for all the unit regions), the contrast evaluation value is acquired by a method similar to the conventional method.

In step S302, the arithmetic unit 207 obtains the range of the AF region 102 as the range for acquiring the contrast evaluation value (a region of interest serving as the target of focus control). For example, the arithmetic unit 207 refers to the given AF region held by the arithmetic unit 207.

In step S303, the arithmetic unit 207 obtains information of the exposure regions having the same exposure condition within the AF region 102 obtained in step S302. In the example shown in FIG. 1, the arithmetic unit 207 obtains information of the range of the low-gain regions 103 and information of the range of the high-gain regions 104. Then, the arithmetic unit 207 obtains, from the exposure region control unit 206, the range having the same exposure condition within the range of the referred AF region.

In step S304, the arithmetic unit 207 calculates the contrast evaluation value for each of the exposure regions each having the same exposure condition. In the example shown in FIG. 1, the arithmetic unit 207 calculates the contrast evaluation value in the range of the low-gain regions 103 and the contrast evaluation value in the range of the high-gain regions 104. That is, the arithmetic unit 207 calculates the contrast evaluation value for the exposure regions having the same exposure condition while driving the lens 202 via the lens control unit 205. Note that if the exposure conditions are not much different from each other, in order to reduce the load, they may be considered to be the same exposure condition and the contrast evaluation value may be collectively calculated.

In step S305, the arithmetic unit 207 obtains the exposure condition for each of the exposure regions each having the same exposure condition. The exposure condition can be obtained from, for example, the exposure region control unit 206. In the example shown in FIG. 1, the arithmetic unit 207 obtains the exposure condition in the low-gain regions 103 and the exposure condition in the high-gain regions 104.

In step S306, based on the obtained exposure conditions, the arithmetic unit 207 calculates the weighting of the contrast evaluation value for each of the same exposure conditions. In the example shown in FIG. 1, the arithmetic unit 207 calculates the weighting in the low-gain region 103 and the weighting in the high-gain region 104. In the calculation of the weighting, a condition other than the gain and the exposure range may be included. For example, the weighting may be determined based on the object existing within the region. For a flat image region such as the sky or the like and an image region where a moving body exists, the weighting may be small. Further, the luminance (brightness) of the region may be considered in the calculation of the weighting.

In step S307, the arithmetic unit 207 calculates the contrast evaluation value of the entire video. More specifically, the arithmetic unit 207 calculates the contrast evaluation value of the entire video from the contrast evaluation values of the respective exposure regions acquired in step S304 and the weightings of the respective exposure regions calculated in step S306.

In the manner described above, the arithmetic unit 207 sequentially calculates the contrast evaluation values of the entire video for each position of the lens 202 (focus lens here). As a result, in the calculation of the contrast evaluation value of the entire video, the weighting of the contrast evaluation value of the region where noise is low becomes relatively large. Therefore, it is possible to derive the contrast evaluation value of the entire video that facilitates the normal detection of the focus plane.

### SPECIFIC EXAMPLE

Taking FIG. 1 as an example, a specific example of derivation of the contrast evaluation value will be described.

First, the arithmetic unit 207 compares the exposure conditions (the gain in the low-gain region 103 and the gain in the high-gain region 104) respectively obtained for the exposure regions having the same exposure condition, and determines the weightings. For the contrast evaluation value of the region where the gain is low like the low-gain region 103, it is determined that noise is low and a large weighting is given. On the other hand, for the contrast evaluation value of the region where the gain is high like the high-gain region 104, it is determined that noise is high and a small weighting is given.

In the calculation of the weighting, it is advantageous to consider the range (surface area) occupied by the respective exposure regions. The arithmetic unit 207 compares the pieces of surface area information respectively obtained, from the region exposure control unit 206, for the exposure regions having the same exposure condition within the AF region 102, and determines the weightings. In FIG. 1, since the range of the low-gain regions 103 is larger, the weighting of the low-gain region 103 is relatively larger.

Let A be the weighting of the low-gain region 103 and B be the weighting of the high-gain region 104 obtained as a result of calculation of the weightings as described above. Note that A>>B here.

Once the weightings are calculated, the arithmetic unit 207 drives the lens 202 by a fine distance via the lens control unit 205, and calculates the contrast evaluation value in the low-gain region 103 and the contrast evaluation value in the high-gain region 104 based on the image signal output from the video processing unit 203.

Then, the arithmetic unit 207 derives the contrast evaluation value of the entire video from the acquired contrast evaluation values while considering the calculated weighting for each exposure region. For example, the contrast evaluation value of the entire video is calculated as:

contrast evaluation value of entire video 101=contrast evaluation value in low-gain region 103×A+contrast evaluation value in high-gain region 104×B

The arithmetic unit 207 drives the position of the lens 202 and sequentially acquires the contrast evaluation values of the entire video corresponding to the lens positions. Then, the arithmetic unit 207 drives the contrast evaluation values of the entire video corresponding to the respective lens positions, and obtains the lens position at which the contrast evaluation value of the entire video is maximum. Thereafter, the arithmetic unit 207 drives, via the lent control unit 205, the lens 202 to the lens position at which the contrast evaluation value is maximum.

Note that if the weighting of the contrast evaluation value for each exposure region as described above is not performed, it is difficult to calculate the maximum value of the contrast evaluation value due to the following reason.

In the high-gain region 104, the high-frequency composition may increase due to the influence of gain noise. Therefore, if the contrast evaluation value of the low-gain region 103 and the contrast evaluation value of the high-gain region 104 are treated equally, the contrast evaluation value of the high-gain region 104 becomes relatively large due to the influence of noise. As a result, the sum of the contrast evaluation value of the low-gain region 103 and the contrast evaluation value of the high-gain region 104 may be maximum at the lens position different from the lens position at which the appropriate focus can be obtained.

As has been described above, according to the first embodiment, in the image capturing apparatus using the image sensor capable of setting the exposure condition for each region, the contrast evaluation value of the entire video is derived using the weighting for the exposure regions having the same exposure condition. Particularly, a small weighting is given to the portion like the high-gain region 104 where the influence of noise is large. On the other hand, a large weighting is given to the portion like the low-gain region 103 where the influence of noise is small. By setting the weightings as described above, it is possible to more suitably derive the contrast evaluation value of the entire video which enables a suitable AF operation.

### Second Embodiment

In the second embodiment, an operation in a case in which the shape of the AF region does not match the shape of the unit region will be described. Note that since the apparatus arrangement is similar to that in the first embodiment (FIGS. 2 and 8), a description thereof will be omitted.

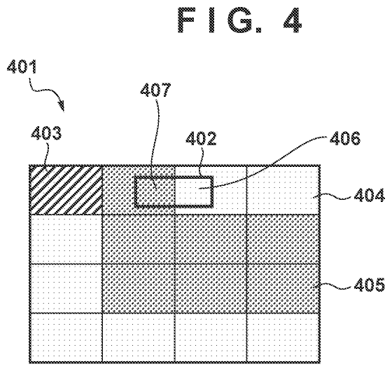

FIG. 4 is a view showing a captured image assumed in the second embodiment, in which different gain settings are mixed. More specifically, FIG. 4 shows a state in which the boundary of the AF region does not match the boundary of the unit region and an AF region 402 includes a part (region 406) of a low-gain region 404 and a part (region 407) of a high-gain region 405. That is, each of the region 406 and the region 407 does not occupy the entire region of the unit region.

### <Operation of Apparatus>

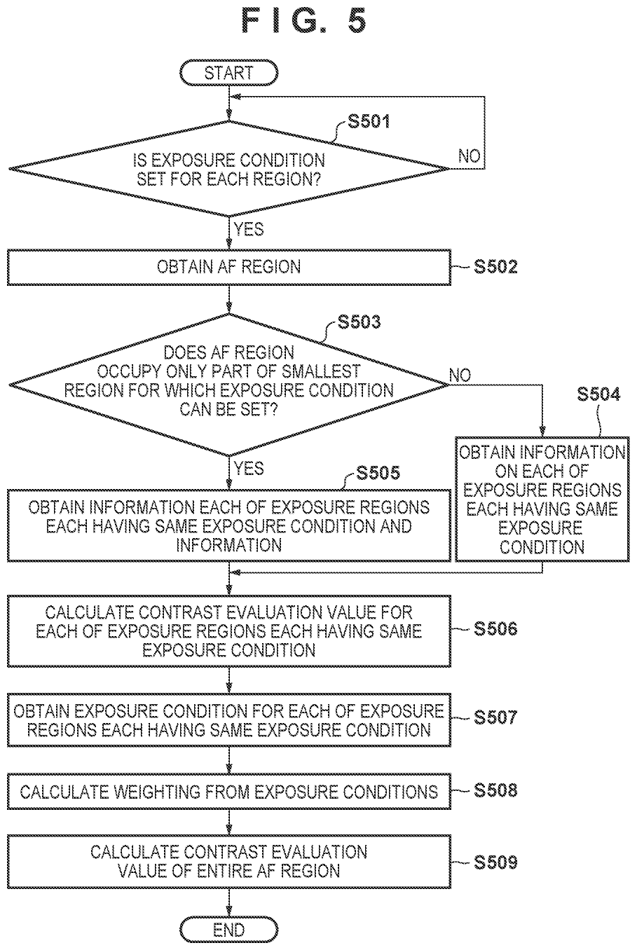

FIG. 5 is a flowchart illustrating an evaluation value deriving operation in the second embodiment. The following operation is started when an image capturing operation is started by a user pressing a button or the like.

In step S501, the arithmetic unit 207 determines whether the exposure condition is set for each region in the image sensor. For example, this determination is made by obtaining setting of the exposure condition from the exposure region control unit 206. If it is determined that the exposure condition is set for each region, the process advances to step S502. Note that if the exposure condition is not set for each region (that is, the exposure condition is the same for all the unit regions), the contrast evaluation value is acquired by a method similar to the conventional method.

In step S502, the arithmetic unit 207 obtains the range of the AF region as the range for acquiring the contrast evaluation value. For example, the arithmetic unit 207 refers to the given AF region held by the arithmetic unit 207. Here, assume that the AF region like the AF region 402 is set.

In step S503, the arithmetic unit 207 determines whether the obtained AF region occupies only a part of the unit region 403 or occupies the entire portion of the unit region 403. If it is determined that the AF region occupies only a part of the unit region (that is, the boundary of the AF region does not match the boundary of the unit region), the process advances to step S505. On the other hand, if it is determined that the AF region occupies the entire portion of the unit region 403 (that is, the boundary of the AF region matches the boundary of the unit region), the process advances to step S504.

In step S504, as in the first embodiment, the arithmetic unit 207 obtains information on each of the exposure regions each having the same exposure condition within the AF region obtained in step S502. In the example shown in FIG. 4, the arithmetic unit 207 obtains information of the range of the low-gain regions 404 and information of the range of the high-gain regions 405. Then, the arithmetic unit 207 obtains, from the exposure region control unit 206, the range having the same exposure condition within the range of the referred AF region.

In step S505, the arithmetic unit 207 obtains information on each of the exposure regions each having the same exposure condition within the AF region obtained in step S502. In the example shown in FIG. 4, the arithmetic unit 207 obtains information of the low-gain region 406 within the AF region and information of the high-gain region 407 within the AF region.

In step S506, the arithmetic unit 207 calculates the contrast evaluation value for each of the exposure regions each having the same exposure condition. In the example shown in FIG. 4, the arithmetic unit 207 calculates the contrast evaluation value in the range of the region 406 and the constant evaluation value in the range of the region 407. That is, the arithmetic unit 207 calculates the contrast evaluation value for the exposure regions having the same exposure condition while driving a lens 202 via a lens control unit 205.

In step S507, the arithmetic unit 207 obtains the exposure condition for each of the exposure regions each having the same exposure condition. The exposure condition can be obtained from, for example, the exposure region control unit 206. In the example shown in FIG. 4, the arithmetic unit 207 obtains the exposure condition in the region 406 and the exposure condition in the region 407.

In step S508, based on the obtained exposure conditions, the arithmetic unit 207 calculates the weighting of the contrast evaluation value for each of the same exposure conditions. In the example shown in FIG. 4, the arithmetic unit 207 calculates the weighting in the region 406 and the weighting in the region 407. In the calculation of the weighting, a condition other than the gain and the exposure range may be included.

In step S509, the arithmetic unit 207 calculates the contrast evaluation value of the entire AF region. More specifically, the arithmetic unit 207 calculates the contrast evaluation value of the entire AF region from the contrast evaluation values of the respective exposure regions acquired in step S506 and the weightings of the respective exposure regions calculated in step S508.

In the manner described above, the arithmetic unit 207 sequentially calculates the contrast evaluation value of the entire AF region for each position of the lens 202 (focus lens here). As a result, in the calculation of the contrast evaluation value of the entire AF region, the weighting of the contrast evaluation value of the region where noise is low becomes relatively large. Therefore, it is possible to derive the contrast evaluation value of the entire AF region that facilitates the normal detection of the focus plane.

As has been described above, according to the second embodiment, even when the boundary of the AF region does not match the boundary of the unit region and the AF region occupies only a part of the unit region, it is possible to suitably derive the contrast evaluation value of the entire AF region.

### Third Embodiment

In the third embodiment, an operation in a case in which a high gain is set for the entire AF region and a plurality of different gains are included will be described. Note that since the apparatus arrangement is similar to that in the first embodiment (FIGS. 2 and 8), a description thereof will be omitted.

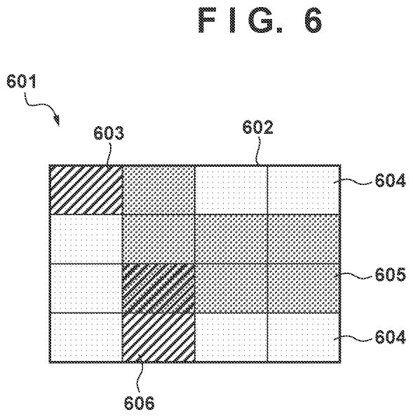

FIG. 6 is a view showing a captured image assumed in the third embodiment, in which different gain settings are mixed. More specifically, this is an example of a video in which, in a video 601 obtained by the entire region of the image sensor, an AF region 602 as the range for acquiring a contrast evaluation value covers the entire video (that is, matches the video 601). The entire region of the video 601 is formed by a plurality of unit regions 603 (a total of 16 unit regions of 4×4 in FIG. 6). Note that the unit region 603 means a region of the minimum unit for which an exposure condition (for example, a gain) can be set independently. In the video 601, nine first high-gain regions 604 and seven second high-gain regions 605 are set in the 16 unit regions 603. Here, it is only required that the gain at the first high-gain region 604 and the gain at the second high-gain region 605 are different from each other, and the magnitude relationship therebetween does not matter.

### <Operation of Apparatus>

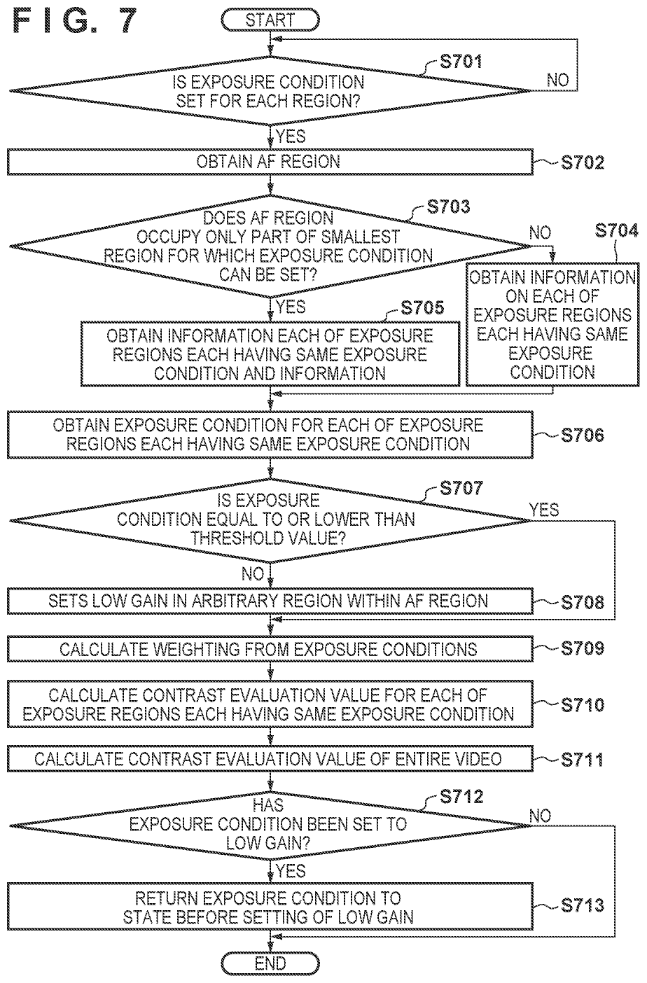

FIG. 7 is a flowchart illustrating an evaluation value deriving operation in the third embodiment. The following operation is started when an image capturing operation is started by a user pressing a button or the like.

In step S701, the arithmetic unit 207 determines whether the exposure condition is set for each region in the image sensor. For example, this determination is made by obtaining setting of the exposure condition from the exposure region control unit 206. If it is determined that the exposure condition is set for each region, the process advances to step S702. Note that if the exposure condition is not set for each region (that is, the exposure condition is the same for all the unit regions), the contrast evaluation value is acquired by a method similar to the conventional method.

In step S702, the arithmetic unit 207 obtains the range of the AF region as the range for acquiring the contrast evaluation value. For example, the arithmetic unit 207 refers to the given AF region held by the arithmetic unit 207. Here, assume that the AF region like the AF region 602 is set.

In step S703, the arithmetic unit 207 determines whether the obtained AF region occupies only a part of the unit region 603 or occupies the entire portion of the unit region 603. If it is determined that the AF region occupies only a part of the unit region (that is, the boundary of the AF region does not match the boundary of the unit region), the process advances to step S705. On the other hand, if it is determined that the AF region occupies the entire portion of the unit region 603 (that is, the boundary of the AF region matches the boundary of the unit region), the process advances to step S704.

In step S704, the arithmetic unit 207 obtains information on each of the exposure regions each having the same exposure condition within the AF region obtained in step S702. In the example shown in FIG. 6, the arithmetic unit 207 obtains information of the range of the first high-gain regions 604 and information of the range of the second high-gain regions 605. Then, the arithmetic unit 207 obtains, from the exposure region control unit 206, the range having the same exposure condition within the range of the referred AF region.

In step S705, the arithmetic unit 207 obtains information on each of the exposure regions each having the same exposure condition within the AF region obtained in step S702.

In step S706, the arithmetic unit 207 obtains the exposure condition for each of the exposure regions each having the same exposure condition. The exposure condition can be obtained from, for example, the exposure region control unit 206. In the example shown in FIG. 6, the arithmetic unit 207 obtains the exposure condition in the first high-gain region 604 and the exposure condition in the second high-gain region 605.

In step S707, the arithmetic unit 207 determines whether the exposure condition obtained in step S706 is equal to or lower than a predetermined threshold value (th). Here, for each of the first high-gain region 604 and the second high-gain region 605, it is determined whether the exposure condition is equal to or lower than the threshold value. If it is determined for the both regions that the exposure condition is equal to or lower than the threshold value, it is determined that the reliability of the contrast evaluation value to be calculated is high, and the process advances to step S709. On the other hand, if it is determined that the exposure condition of at least one of the regions is higher than the threshold value, it is determined that the reliability of the contrast evaluation value to be acquired is low, and the process advances to step S708.

Note that the predetermined threshold value (th) can be, for example, half the difference between the maximum value (top) and the minimum value (min) settable in the exposure condition (the gain here).

th=(top−min)/2

In step S708, the arithmetic unit 207 sets a low gain in an arbitrary region within the AF region. Here, the gain of the region where the low gain is set is set to be equal to or lower than the above-described threshold value (th). In the example shown in FIG. 6, the arithmetic unit 207 sets a low gain in a region 606 via the exposure region control unit 206.

In step S709, based on the exposure condition obtained in step S706 or set in step S708, the arithmetic unit 207 calculates the weighting of the contrast evaluation value for each of the same exposure conditions. In the example shown in FIG. 6, the arithmetic unit 207 calculates the weighting in each of the region 604, the region 605, and the region 606. In the calculation of the weighting, a condition other than the gain and the exposure range may be included.

In step S710, the arithmetic unit 207 calculates the contrast evaluation value for each of the same exposure conditions based on the exposure condition obtained in step S706 or set in step S708. In the example shown in FIG. 6, the arithmetic unit 207 calculates the contrast evaluation value in each of the region 604, the region 605, and the region 606. That is, the arithmetic unit 207 calculates the contrast evaluation value for the exposure regions having the same exposure condition while driving a lens 202 via a lens control unit 205.

In step S711, the arithmetic unit 207 calculates the contrast evaluation value of the entire video. More specifically, the arithmetic unit 207 calculates the contrast evaluation value of the entire video from the contrast evaluation values of the respective exposure regions acquired in step S710 and the weightings of the respective exposure regions calculated in step S709.

In step S712, the arithmetic unit 207 obtains information as to whether the low gain has been set (step S708). If the low gain has been set, the process advances to step S713. If the low gain has not been set, the process is terminated.

In step S713, the arithmetic unit 207 returns the exposure condition of the region 606, where the low gain has been set, to the exposure condition before the setting of the low gain. That is, the arithmetic unit 207 returns the exposure condition of the region 606 to the previous exposure condition via the exposure region control unit 206.

As has been described above, according to the third embodiment, if a gain higher than a predetermined threshold value of the AF region has been set, a gain lower than the predetermined threshold value is set in an arbitrary region of the AF region and the contrast evaluation value is derived. That is, by intentionally generating the low-gain region and deriving the contrast evaluation value, the reliability of the contrast evaluation value of the entire video can be increased.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a RAM, a ROM, a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-091805, filed May 31, 2021 which is hereby incorporated by reference herein in its entirety.

What is claimed is:

1. An image capturing apparatus comprising:
an image capturing circuit configured to generate an image signal from an image of an object formed by an optical system;
a processor; and
a memory containing instructions that, when executed by the processor, cause the processor to perform operations comprising:
an image processing unit configured to generate image data based on the image signal,
a determination unit configured to determine a first exposure condition to be applied to a first region and a second exposure condition to be applied to a second region different from the first region in an image capturing surface of the image capturing circuit,
an acquisition unit configured to acquire, based on the image data, a first evaluation value indicating a degree of contrast in the first region and a second evaluation value indicating a degree of contrast in the second region,
a calculation unit configured to calculate a third evaluation value indicating a degree of contrast in the image data based on the first evaluation value and the second evaluation value weighted based on the first exposure condition and the second exposure condition, and
a control unit configured to perform focus control of the optical system based on the third evaluation value.

2. The apparatus according to claim 1, wherein the operations further comprising
a region obtainment unit configured to obtain a region of interest serving as a target of the focus control in the image data,
wherein the acquisition unit acquires the first evaluation value and the second evaluation value in the region of interest, and
the calculation unit derives the third evaluation value in the region of interest.

3. The apparatus according to claim 1, wherein the operations further comprising
a determination unit configured to determine a weighting for the first evaluation value and a weighting for the second evaluation value based on the first exposure condition and the second exposure condition.

4. The apparatus according to claim 3, wherein
the weighting determination unit determines the weighting for the first evaluation value and the weighting for the second evaluation value further based on an object existing in the first region and an object existing in the second region.

5. The apparatus according to claim 3, wherein
the weighting determination unit determines the weighting for the first evaluation value and the weighting for the second evaluation value further based on a luminance in the first region and a luminance in the second region.

6. The apparatus according to claim 1, wherein
each of the first exposure condition and the second exposure condition is an exposure condition concerning a noise amount.

7. The apparatus according to claim 6, wherein
each of the first exposure condition and the second exposure condition is a gain or an exposure time.

8. The apparatus according to claim 6, wherein the operations further comprising
a decision unit configured to decide whether each of the first exposure condition and the second exposure condition exceeds a predetermined threshold value,
wherein, if it is decided that at least one of the first exposure condition and the second exposure condition exceeds the predetermined threshold value, the determination unit further determines a third exposure condition not higher than the predetermined threshold value in an arbitrary third region of the image capturing circuit.

9. A control method of an image capturing apparatus which includes an image capturing circuit configured to generate an image signal from an image of an object formed by an optical system and an image processing circuit configured to generate image data based on the image signal,
the control method comprising:
determining a first exposure condition to be applied to a first region and a second exposure condition to be applied to a second region different from the first region in an image capturing surface of the image capturing circuit;
acquiring, based on the image data, a first evaluation value indicating a degree of contrast in the first region and a second evaluation value indicating a degree of contrast in the second region;
calculating a third evaluation value indicating a degree of contrast in the image data based on the first evaluation value and the second evaluation value weighted based on the first exposure condition and the second exposure condition; and
performing focus control of the optical system based on the third evaluation value.

10. A non-transitory computer-readable recording medium storing a program for causing a computer to execute a control method of an image capturing apparatus which includes an image capturing circuit configured to generate an image signal from an image of an object formed by an optical system and an image processing circuit configured to generate image data based on the image signal,
the control method comprises:
determining a first exposure condition to be applied to a first region and a second exposure condition to be applied to a second region different from the first region in an image capturing surface of the image capturing circuit;
acquiring, based on the image data, a first evaluation value indicating a degree of contrast in the first region and a second evaluation value indicating a degree of contrast in the second region;
calculating a third evaluation value indicating a degree of contrast in the image data based on the first evaluation value and the second evaluation value weighted based on the first exposure condition and the second exposure condition; and
performing focus control of the optical system based on the third evaluation value.
